(19) United States
(12) Patent Application Publication
(10) Pub. No.: US 2025/0105331 A1
(43) Pub. Date: Mar. 27, 2025

(54) DEVICE FOR PREVENTING MISALIGNMENT OF RECHARGEABLE BATTERY ELECTRODE

(71) Applicant: Samsung SDI Co., Ltd., Yongin-si (KR)

(72) Inventors: GIWOOK LEE, Yongin-si (KR); Junghyun Lee, Yongin-si (KR); Junhyeok Kwak, Yongin-si (KR); Jeongyi Park, Yongin-si (KR); Hyunchul Kim, Yongin-si (KR); Hyemin Park, Yongin-si (KR)

(21) Appl. No.: 18/617,921

(22) Filed: Mar. 27, 2024

(30) Foreign Application Priority Data
Sep. 27, 2023 (KR) 10-2023-0130989

(51) Int. Cl. H01M 10/04

(52) U.S. Cl. CPC H01M 10/0409

(57) ABSTRACT

A device for preventing meandering of a rechargeable battery electrode includes an unwinder configured to supply an electrode plate including a coated region and an uncoated region to an electrode substrate, at least one guide roll configured to provide a tension to the electrode plate supplied from the unwinder and configured to support the electrode plate and a rewinder for rewinding the electrode plate passed through the guide roll, wherein the electrode plate has a step h in a boundary of the uncoated region and the coated region, and wherein the guide roll(s) includes a first support portion having a first radius and corresponding to the coated region, and a second support portion having a second radius that is greater than the first radius and corresponding to the uncoated region.

### CROSS-REFERENCE TO RELATED APPLICATION

This application claims priority to and the benefit of Korean Patent Application No. 10-2023-0130989 filed in the Korean Intellectual Property Office on Sep. 27, 2023, the entire contents of which are incorporated herein by reference.

### BACKGROUND

### 1. Field

The present disclosure relates to a device for preventing meandering of a rechargeable battery electrode.

### 2. Description of the Related Art

A rechargeable battery is a battery that is repeatedly charged and discharged, unlike a primary battery. A small capacity rechargeable battery is used in a small portable electronic device such as a mobile phone, a notebook computer, and a camcorder, while a large capacity rechargeable battery may be used as a power source for driving a motor of a hybrid vehicle and an electric vehicle.

A rechargeable battery typically includes an electrode assembly for charging and discharging, a pouch accommodating the electrode assembly, and an electrode tab that electrically connects the electrode assembly and draws it out of the pouch.

The electrode assembly includes a winding type in which a negative electrode plate and a positive electrode plate are wound with a separator interposed therebetween, and a stacking type in which a negative electrode plate and a positive electrode plate are stacked with a separator interposed therebetween.

However, a difference of elongation is generated between an uncoated region and a coated region because of a difference of tensions applied between the uncoated region and the coated region on the electrode plate. The electrode plate may be deformed and fractured because of the difference of elongation rates.

### SUMMARY

Embodiments include a device for preventing meandering of a rechargeable battery electrode. The device includes an unwinder configured to supply an electrode plate including a coated region and an uncoated region to an electrode substrate, at least one guide roll configured to provide a tension to the electrode plate supplied from the unwinder and configured to support the electrode plate and a rewinder for rewinding the electrode plate passed through the guide roll, wherein the electrode plate has a step h in a boundary of the uncoated region and the coated region, and the guide roll includes a first support portion supporting having a first radius and corresponding to the coated region and a second support portion supporting having a second radius that is greater than the first radius and corresponding to the uncoated region.

The second support portion may be installed on an external side of the guide roll and may be formed of a step compensating material having a first thickness t1 to support the uncoated region for forming the step.

A pair of press rolls configured to pressurize the electrode plate may be installed on one side of the guide roll.

A slitting unit configured to slit the electrode plate may be installed on one side of the guide roll.

The second support portion may include an adhesive film attached to an external surface of the guide roll.

A first thickness t1 of the second support portion may be greater than the step h.

A first thickness t1 of the second support portion may be set as 2 h≤t1<5h.

The electrode plate may include coated regions and uncoated regions installed outside the coated regions, and the step compensating material may include a first compensating material and a second compensating material installed corresponding to the uncoated region on respective outermost sides from among the uncoated regions and supporting the uncoated region.

The guide roll may further include a third support portion supporting the uncoated region disposed between the coated regions from among the uncoated regions and having a second radius.

The step compensating material may further include a third compensating material installed corresponding to the uncoated region disposed between the coated regions and supporting the uncoated region.

The electrode plate may further include an insulation coating layer near a boundary of the coated region and the uncoated region, and the guide roll may further include a fourth support portion supporting the insulation coating layer and having a third radius that is greater than the first radius and less than the second radius.

The insulation coating layer may have a step h2 that is less than the step h of the coated region.

### BRIEF DESCRIPTION OF THE DRAWINGS

Features will become apparent to those of ordinary skill in the art by describing in detail exemplary embodiments with reference to the attached drawings in which:

FIG. 1 shows a schematic diagram of a device for preventing meandering of a rechargeable battery electrode according to one or more embodiments of the present disclosure;

FIG. 2 shows a cross-sectional view in which a guide roll of FIG. 1 supports an electrode plate according to one or more embodiments;

FIG. 3 shows a cross-sectional view in which a guide roll applied to a device for preventing meandering of a rechargeable battery electrode according to one or more embodiments of the present disclosure supports an electrode plate;

FIG. 4 shows a schematic diagram of a device for preventing meandering of a rechargeable battery electrode according to one or more embodiments of the present disclosure;

FIG. 5 shows a perspective view in which a guide roll of FIG. 4 supports an electrode plate according to one or more embodiments; and

FIG. 6 shows a partial cross-sectional view with respect to a line VI-VI of FIG. 5 according to one or more embodiments.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those of ordinary skill in the art.

As used herein, the terms “first,” “second,” and the like are merely for identification and differentiation, and are not intended to imply or require sequential inclusion (e.g., a third element and a fourth element may be described without implying or requiring the presence of a first element or second element). In the drawing figures, the dimensions of layers and regions may be exaggerated for clarity of illustration. It will also be understood that if a layer or element is referred to as being “on” another layer or substrate, it can be directly on the other layer or substrate, or intervening layers may also be present. Further, it will be understood that if a layer is referred to as being “under” another layer, it can be directly under, and one or more intervening layers may also be present. In addition, it will also be understood that if a layer is referred to as being “between” two layers, it can be the only layer between the two layers, or one or more intervening layers may also be present. Like reference numerals refer to like elements throughout the specification.

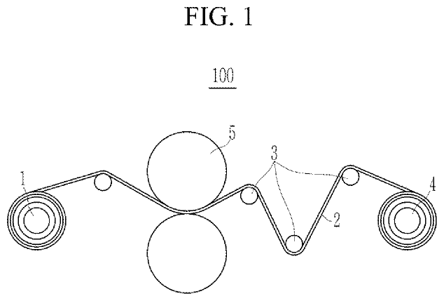

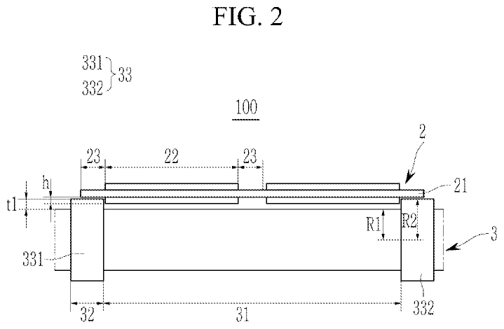

FIG. 1 shows a schematic diagram of a device for preventing meandering of a rechargeable battery electrode according to one or more embodiments of the present disclosure, and FIG. 2 shows a cross-sectional view in which a guide roll of FIG. 1 supports an electrode plate according to one or more embodiments. Referring to FIG. 1 and FIG. 2, the device 100 for preventing meandering of a rechargeable battery electrode 100 may unwind an electrode plate 2 wound on an unwinder 1 to progress, may support the electrode plate 2 with a guide roll 3, and may wind the progressed electrode plate 2 on a rewinder 4 through the guide roll 3. For example, the guide roll 3 supporting the progressed electrode plate 2 may include one or more guide rolls.

The electrode plate 2 may include a coated region 22 formed by coating active material slurry on an electrode substrate 21 and an uncoated region 23 formed by not coating the active material slurry on at least one side of the coated region 22 in a width direction (e.g., a left to right or x axis direction in FIG. 2) that is orthogonal to a progressing direction (e.g., a left to right or x axis direction in FIG. 1). The electrode plate 2 has a step h because of different thicknesses of the coated region 22 and the uncoated region 23, that is, the step h is set to be the thickness of the coated region 22 on a surface of the electrode substrate 21.

The guide roll 3 may include a first support portion 31 supporting the coated region 22 of the electrode plate 2 arranged corresponding to the coated region 22 to progress and having a first radius R1, and a second support portion 32 supporting the uncoated region 23 of the electrode plate 2 arranged corresponding to the uncoated region 23 to progress and having a second radius R2 that is greater than the first radius R1.

In some embodiments, the second support portion 32 may be formed with a step compensating material 33 having a first thickness t1 on an external side of the guide roll 3, and the step compensating material 33 may support the uncoated region 23 with the step h with respect to the coated region 22. The step compensating material 33 may be formed with an adhesive film attached to the guide roll 3. The step compensating material 33 may attach the adhesive film or an adhesive tape corresponding to the uncoated region 23 to apply a tension to the uncoated region 23.

The meandering preventing device 100 according to one or more embodiments may be applied to a press device for pressurizing the electrode plate 2. The meandering preventing device 100 may further include a pair of press rolls 5 installed on one side of the guide roll 3 and pressurizing the electrode plate 2. The pair of the press rolls 5 may progress the electrode plate 2 on which the active material coated region 22 is formed to the electrode substrate 21 to thus increase density of the active material in the coated region 22.

The first thickness t1 of the second support portion 32 may be formed to be greater than the step h. Therefore, if the electrode plate 2 passes through the guide roll 3, the second support portion 32 may apply a greater tension to the uncoated region 23 than if the coated region 22 contacts the first support portion 31.

Non-uniform elongation of the electrode plate 2 in the press process in which the electrode plate 2 passes through the press roll 5 may occur. For example, the pressure by the press roll 5 may work to the coated region 22. Therefore, deviation of an elongation amount may occur in the coated region 22 and the uncoated region 23.

By this, stresses may be generated according to elongation amount deviation of the coated region 22 and the uncoated region 23. For example, a stress by which the uncoated region 23 relatively shrinks may be generated by a deviation of the elongation amount by which the elongation amount of the coated region 22 increases compared to the uncoated region 23. A stress stretching in an opposite direction may be generated in the coated region 22.

The second support portion 32 may include the step compensating material 33 and may increase a diameter of the guide roll 3.

In some embodiments, a greater tension may be applied to the uncoated region 23 having the step h than to the coated region 22, while undergoing the press process. A vertical drag applied to the electrode plate 2 that is tangent to the guide roll 3 may increase in proportion to the tension so the greater vertical drag may be applied to the uncoated region 23 than to the coated region 22.

The step compensating material 33 having increased the diameter of the guide roll 3 in the second support portion 32 may reach the uncoated region 23. Thus, the uncoated region 23 may contact the guide roll 3 and may be elongated while receiving pressures from the guide roll 3. Therefore, in spite of the step h, the deviation of the elongation amount may be reduced or removed in the uncoated region 23 and the coated region 22.

In an example embodiment, the first thickness t1 of the second support portion 32 may be set to be 2 h≤t1<5 h. If the first thickness t1 is less than twice (2 h) the step h, an effect of compensating the step may be insufficient, the reduction of the deviation of elongation amount may be insufficient in the coated region 22 and the uncoated region 23, and no desired effect may be obtained.

If the first thickness t1 is greater than five times (5 h) the step h and the coated region 22 contacts the first support portion 31, a substantial weight may be applied to the uncoated region 23 and the electrode plate 2 may be fractured.

Hence, if the first thickness t1 of the second support portion 32 is within a range of 2h≤t1<5 h, the pressure may be applied to the uncoated region 23 to thus increase the elongation of the uncoated region 23 and prevent meandering of the electrode plate 2.

Referring to FIG. 2, the electrode plate 2 may include coated regions 22 and uncoated regions 23 disposed outside the coated regions 22. In some embodiments, the step compensating material 33 may include a first compensating material 331 and a second compensating material 332.

The first compensating material 331 and the second compensating material 332 may be installed corresponding to the uncoated regions 23 on respective outermost sides from among the uncoated regions 23 and may support the uncoated regions 23 disposed on the respective outermost sides. In some embodiments, the step compensating material 33 may not be installed in the uncoated region 23 having the coated regions 22 on respective sides.

The first and second compensating materials 331 and 332 may increase a diameter of the guide roll 3 from the respective sides. The uncoated regions 23 on respective ends not contacting the guide roll 3 contact the guide roll 3 through the first and second compensating materials 331 and 332, thereby receiving the pressure. By this, the deviation of the elongation amount may be reduced or removed in the uncoated region 23, the coated region 22 and the uncoated region 23 arranged in the width direction.

In an example embodiment, the diameter of the guide roll 3 having increased through the first and second compensating materials 331 and 332 may disperse the pressure vertically applied to the electrode plate 2 from the respective ends in the width direction to the increased area. By this, the electrode plate 2 may be prevented from being excessively elongated in the vertical direction at the respective ends in the width direction. Accordingly, generation of waves on the electrode plate 2 and generation of fractures at the respective ends in the width direction may be prevented.

Various embodiments of the present disclosure will now be described. Descriptions on the same configurations will be omitted in comparison to the above-described embodiments, and different configurations will now be described.

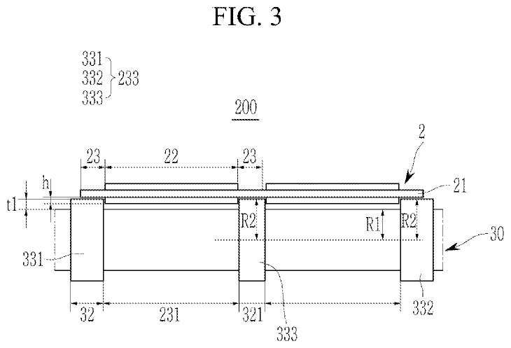

FIG. 3 shows a cross-sectional view in which a guide roll applied to a device for preventing meandering of a rechargeable battery electrode according to one or more embodiments of the present disclosure supports an electrode plate. Referring to FIG. 3, regarding the meandering preventing device 200, the guide roll 30 may include a first support portion 231 supporting the coated region 22 corresponding to the coated region 22 and having a first radius R1, and a second support portion 32 supporting the uncoated region 23 corresponding to the uncoated region 23 and having a second radius R2 that is greater than the first radius R1. The guide roll 30 may further include a third support portion 321 supporting the uncoated region 23 disposed between (in the center, for ease of description) the coated regions 22 on respective sides and having a second radius R2.

For example, the step compensating material 233 may include a first compensating material 331, a second compensating material 332 and a third compensating material 333. The third compensating material 333 may correspond to the uncoated region 23 disposed in the center and may support the uncoated region 23. The first, second, and third compensating materials 331, 332, and 333 may respectively increase the diameter of the guide roll 30 at the respective sides and in the center. The uncoated region 23 at the respective ends and in the center not contacting the guide roll 30 contact the guide roll 30 through the first, second and third compensating materials 331, 332, and 333, thereby receiving the pressure. By this, the deviation of the elongation amount may be reduced or removed in the uncoated region 23, the coated region 22, the uncoated region 23 and the coated region 22 arranged in the width direction of the electrode plate 2.

In another example, the diameter of the guide roll 30 having increased through the first, second, third compensating materials 331, 332, and 333 may disperse the pressure vertically applied to the electrode plate 2 from the respective ends in the width direction and the center to the increased area. By this, the electrode plate 2 may be prevented from being excessively elongated in the vertical direction at the respective ends in the width direction and in the center and generation of waves on the electrode plate 2 and generation of fractures may be prevented.

Comparative examples 1 to 4 may be compared to experimental examples 1 to 5 and will now be described with reference to Table 1. The comparative example 1 and the experimental example 1 may not apply the first compensating material 331, the second compensating material 332 and the third compensating material 333 and may set a ratio of t1/h as 0.5 and 3, respectively. The comparative examples 2, 3, 4 and the experimental examples 2 to 3 may correspond to applying the first compensating material 331 and the second compensating material 332, and may set the ratio as 1 to 7. The experimental examples 4 and 5 may correspond to the second embodiment applying the first compensating material 331, the second compensating material 332 and the third compensating material 333, and may set the ratio of t2/h2 as 2 and 3, respectively.

TABLE 1

| | Presence/absence | Presence/absence | | | |
|---|---|---|---|---|---|
| | of first and second | of third | | | |
| | compensating | compensating | t1/h, | Improving rates (%) | |
| | materials | material | t2/h2 | Curve | Meandering |
| Comparative | X | X | 0.5 | −19.3 | −58.8 |
| Example 1 | | | | | |
| Experimental | X | X | 3 | 40.0 | 30.9 |
| Example 1 | | | | | |
| Comparative | ◯ | X | 1 | −54.0 | 16.9 |
| Example 2 | | | | | |
| Experimental | ◯ | X | 2 | 40.0 | 45.4 |
| Example 2 | | | | | |
| Experimental | ◯ | X | 3 | 56.0 | 65.2 |
| Example 3 | | | | | |
| Comparative | ◯ | X | 5 | 72.0 | 72.5 |
| Example 3 | | | | | |
| Comparative | ◯ | X | 7 | 84.0 | 84.1 |
| Example 4 | | | | | |
| Experimental | ◯ | ◯ | 2 | 34.1 | 40.2 |
| Example 4 | | | | | |
| Experimental | ◯ | ◯ | 3 | 93.3 | 93.1 |
| Example 5 | | | | | |

The improving rates (%) of curves and meandering may be expressed by the following equation:

$$m ( \% ) = \frac{{m}_{1} - {m}_{2}}{{m}_{1}} \times 100$$

In the above equation, m₁ represents the curve and meandering values to which the existing film is applied in the comparative examples 2 to 4 and the experimental examples 2 to 5, and m₂ is the curve and meandering values in which the adhesive film is applied to first compensating material 331, the second compensating material 332 and the third compensating material 333.

In the experimental example 1, the curve and meandering of the electrode plate 2 are improved at t1/h=3, in the experimental examples 2 and 3, the curve and meandering of electrode plate 2 are improved at t1/h=2, 3, and the experimental examples 4 and 5, and the curve and meandering of electrode plate 2 are improved at t2/h2=2 and 3.

In the comparative example 3, a wave phenomenon of the electrode plate 2 worsened at t1/h=5, and in the experimental example 4, the electrode plate 2 is fractured at t1/h=7 and is not rewound.

Therefore, it is given as 2≤t1/h≤3 if applying the first compensating material 331 and the second compensating material 332, and it may be found that the curve and meandering of the electrode plate 2 are improved if applying the first compensating material 331, the second compensating material 332, and the third compensating material 333 and it is given as 2≤t2/h2≤3. In addition, it may be found that the curve and meandering of the electrode plate 2 are improved if it is given as t1/h=3 without applying the first compensating material 331, the second compensating material 332 or the third compensating material 333.

In addition, if the comparative examples 3 and 4 applying the first compensating material 331 and the second compensating material 332 are considered and it is given as t1/h>5, the curve and meandering of the electrode plate 2 are improved, but if the wave phenomenon of the electrode plate 2 became worse and the electrode plate 2 is fractured to fail to progress rewinding, it may be found that it is given as t1/h<5.

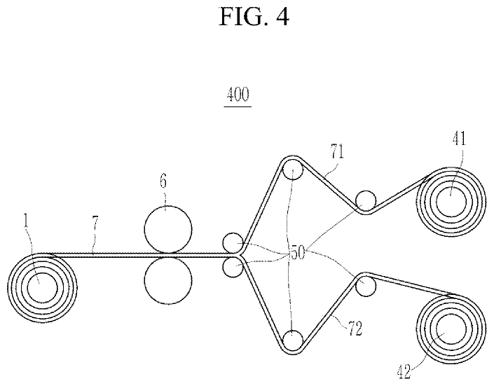

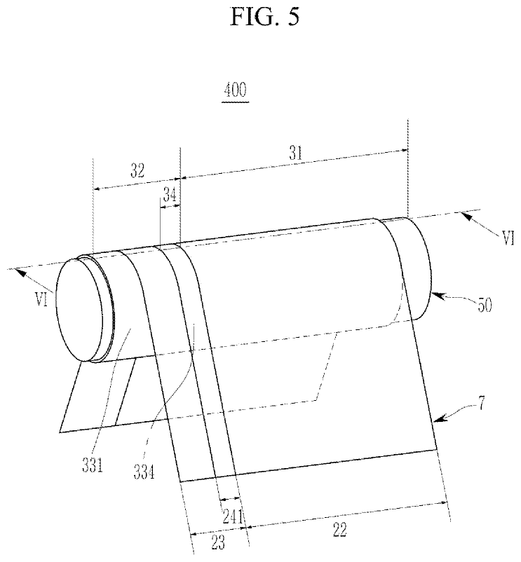

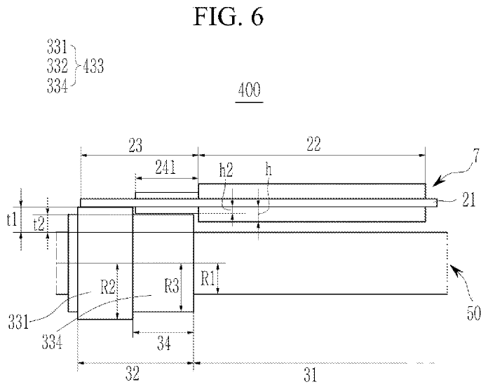

FIG. 4 shows a schematic diagram of a device for preventing meandering of a rechargeable battery electrode according to one or more embodiments of the present disclosure, FIG. 5 shows a perspective view in which a guide roll of FIG. 4 supports an electrode plate, and FIG. 6 shows a partial cross-sectional view with respect to a line VI-VI of FIG. 5.

Referring to FIGS. 4 to 6, the meandering preventing device 400 according to one or more embodiments may be applied to a slitting device for slitting the electrode plate 7. The meandering prevention device 400 according to this embodiment may further include a pair of slitting units 6 disposed on one side of the guide roll 50 and pressurizing the electrode plate 7. The electrode plate 7 may pass through the slitting units 6 and may be divided into multiple pieces.

Therefore, the meandering prevention device 400 according to some embodiments may wind the electrode plates 7 including 71 and 72 progressed after they are slit on the first and second rewinders 41 and 42, and may include one or more guide rolls 50 supporting the progressed electrode plates 7 including 71 and 72.

During the slitting process, the electrode plates 7 including 71 and 72 may be bent. While slitting the electrode plates 7 including 71 and 72, the stress in the coated region 22 may decrease due to a decrease in the width of the coated region 22. The electrode plates 7 including 71 and 72 may be bent in a length direction because of the stress of the uncoated region 23.

The electrode plates 7 including 71 and 72 may further include an insulation coating layer 241 near a boundary between the coated region 22 and the uncoated region 23. The insulation coating layer 241 may prevent cracks in the coated region 22 and may prevent short circuits due to deformation of the electrode substrate 21 in the completed rechargeable battery.

The guide roll 50 may include a first support portion 31 supporting the coated region 22 and having a first radius R1, a second support portion 32 supporting the uncoated region 23 and having a second radius R2 that is greater than the first radius R1, and a fourth support portion 34 supporting the insulation coated layer 241 and having a third radius R3. The third radius R3 may be set to be greater than the first radius R1 and less than the second radius R2, i.e., R2>R3>R1.

The insulation coating layer 241 may have a step (h2) that is smaller than the step h of the coated region 22. The step compensating material 433 may be provided on the external side of the guide roll 50, and may further include a fourth compensating material 334 having a second thickness t2 that is less than the first thickness t1 to support the insulation coating layer 241.

For convenience, one end of the guide roll 50 will be described. The first and fourth compensating materials 331 and 334 may gradually increase the diameter of the guide roll 50, respectively. As an example, the first and fourth compensating materials 331 and 334 may be formed of adhesive films, may be formed by attaching multiple layers of the adhesive films and may each be formed with different numbers of layers.

The uncoated region 23 and the insulation coating layer 241, which were not in direct contact with the guide roll 50, may gradually come into direct contact with the guide roll 50 through the first and fourth compensating materials 331 and 334, and may thus receive pressure. Due to this, the deviation of the elongation amount may be reduced or removed in the uncoated region 23, the insulation coating layer 241 and the coated region 22 arranged in the width direction in electrode plate 7.

As the pressure acts on the uncoated region 23 and the insulation coating layer 241, the elongation of the uncoated region 23 and the insulation coating layer 241 may be gradually increased to prevent the curve of electrode plate 7.

Asymmetry of the tension in the width direction caused by bending of the electrode plate 7 may be prevented. For example, the uncoated region 23 and the insulation coating layer 241 may be supported by the first and fourth compensating materials 331 and 334 so the uniform tension may be applied in the width direction of the electrode plate 7. The pressure caused by the guide roll 50 may act evenly across the entire width direction of the electrode plate 7. In this manner, the electrode plate 7 may be prevented from being bent.

For example, the diameter of the guide roll 50, which may be gradually increased through the first and fourth compensating materials 331 and 334, may disperse the pressure applied vertically to the electrode plate 7 at one end of the width direction to the gradually increased area. As a result, excessive elongation of the electrode plate 7 in the vertical direction at one end of the width direction may be gradually prevented. For example, the generation of waves on the electrode plate 7 and the generation of fractures may be prevented.

The present disclosure provides a device for preventing meandering of a rechargeable battery electrode by applying an additional tension to an uncoated region and increasing elongation of the uncoated region.

The present disclosure also provides a device for preventing meandering of a rechargeable battery electrode by stepwise increasing elongation of an uncoated region and an insulation coating layer by stepwise applying additional tension to the uncoated region and the insulation coating layer.

Thus, the uncoated region may receive additional elongation by the support of the second support portion with the first and second radii, and the additional elongation may prevent the deformation of the uncoated region, such as a curve shape.

Therefore, the uncoated region and the insulation coating layer may stepwise receive additional elongation by the support of the second and fourth support portions having the first, second, and third radius differences, and the additional elongation may prevent the deformation of the uncoated region and the insulation coating layer such as the curve shape.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

<Description of symbols>

| | |
|---|---|
| 1: unwinder | 2: electrode plate |
| 3: guide roll | 4: rewinder |
| 5: press roll | 6: slitting unit |
| 7, 71, 72: electrode plate | 21: electrode substrate |
| 22: coated region | 23: uncoated region |
| 30: guide roll | 31: first support portion |
| 32: second support portion | 33: step compensating material |
| 34: fourth support portion | 41, 42: first and second rewinders |
| 50: guide roll | 100: meandering preventing device |
| 200: meandering preventing device | 231: first support portion |
| 233: step compensating material | 241: insulation coating layer |
| 321: support portion | 331: first compensating material |
| 332: second compensating material | 333: third compensating material |
| 334: fourth compensating material | 400: meandering preventing device |
| 433: step compensating material | h, h2: step |
| R1: first radius | R2: second radius |
| t1: first thickness | t2: second thickness |

What is claimed is:

1. A device for preventing meandering of a rechargeable battery electrode comprising:
an unwinder configured to supply an electrode plate including a coated region and an uncoated region to an electrode substrate;
at least one guide roll configured to provide a tension to the electrode plate supplied from the unwinder and configured to support the electrode plate; and
a rewinder for rewinding the electrode plate passed through the guide roll,
wherein the electrode plate has a step h in a boundary of the uncoated region and the coated region, and wherein the at least one guide roll includes,
a first support portion having a first radius and corresponding to the coated region, and
a second support portion having a second radius that is greater than the first radius and corresponding to the uncoated region.

2. The device as claimed in claim 1, wherein the second support portion is installed on an external side of the guide roll, and is formed of a step compensating material having a first thickness t1 to support the uncoated region for forming the step.

3. The device as claimed in claim 1, wherein a pair of press rolls configured to pressurize the electrode plate are installed on one side of the guide roll.

4. The device as claimed in claim 1, wherein a slitting unit configured to slit the electrode plate is installed on one side of the guide roll.

5. The device as claimed in claim 1, wherein the second support portion includes an adhesive film attached to an external surface of the guide roll.

6. The device as claimed in claim 1, wherein a first thickness t1 of the second support portion is greater than the step h.

7. The device as claimed in claim 6, wherein a first thickness t1 of the second support portion is set as 2 h≤t1<5 h.

8. The device as claimed in claim 2, wherein
the electrode plate includes coated regions and uncoated regions installed outside the coated regions, and
the step compensating material includes a first compensating material and a second compensating material installed corresponding to the uncoated region on respective outermost sides from among the uncoated regions and supporting the uncoated region.

9. The device as claimed in claim 8, wherein the guide roll further includes a third support portion supporting the uncoated region disposed between the coated regions from among the uncoated regions and having a second radius.

10. The device as claimed in claim 9, wherein the step compensating material further includes a third compensating material installed corresponding to the uncoated region disposed between the coated regions and supporting the uncoated region.

11. The device as claimed in claim 8, wherein
the electrode plate further includes an insulation coating layer near a boundary of the coated region and the uncoated region, and
the guide roll further includes a fourth support portion supporting the insulation coating layer and having a third radius that is greater than the first radius and less than the second radius.

12. The device as claimed in claim 11, wherein the insulation coating layer has a step h2 that is less than the step h of the coated region.

13. The device as claimed in claim 12, wherein the step compensating material further includes a fourth compensating material installed on an external side of the guide roll and having a second thickness t2 that is less than the first thickness t1 to support the insulation coating layer.
